(19) United States
(12) Patent Application Publication
(10) Pub. No.: US 2015/0259834 A1
(43) Pub. Date: Sep. 17, 2015

(54) FABRIC STRUCTURE

(71) Applicant: MACKENT FABRICS CO., LTD., TAOYUAN CITY (TW)

(72) Inventor: Tai-Li HSIAO, TAOYUAN CITY (TW)

(21) Appl. No.: 14/723,111

(22) Filed: May 27, 2015

Related U.S. Application Data
(63) Continuation-in-part of application No. 14/199,253, filed on Mar. 6, 2014.

(30) Foreign Application Priority Data
Aug. 28, 2013 (TW) 102216195

(51) Int. Cl. D04B 21/16; D04B 21/08; D04B 21/20; B32B 5/02; B32B 5/26

(52) U.S. Cl. CPC D04B 21/16; B32B 5/026; B32B 5/26; D04B 21/207; D04B 21/08; B32B 2250/03; B32B 2250/20; B32B 2307/724; B32B 2307/726; B32B 2437/00; D10B 2501/02; D10B 2331/04; D10B 2331/10

(57) ABSTRACT

A fabric structure is provided. The fabric structure includes an upper fabric layer knitted with a plurality of first PET (polyethylene terephthalate) fibers and a plurality of first PU (polyurethane) fibers; a lower fabric layer 100% knitted with a plurality of second PU fibers; and a central fabric layer interposed between said upper fabric layer and said lower fabric layer, knitted with a plurality of wave-like second PET fibers, wherein crests of the wave-like second PET fibers are intertwined with the upper fabric layer, and wherein troughs of the wave-like second PET fibers are intertwined with the lower fabric layer. The fabric structure features superior stretchability, superior resilience, mild stickiness and slip-proolhess.

This is a continuation-in-part of application Ser. No. 14/199,253, filed Mar. 6, 2014 for which priority is claimed under 35 U.S.C. 120; and this application claims priority of Application No. 102216195 filed in Taiwan on Aug. 28, 2013 under 35 U.S.C. 119, the entire contents of all of which are hereby incorporated by reference.

### BACKGROUND OF THE INVENTION

1. Technical Field

The present invention relates to an improved fabric structure and, more particularly, to a novel fabric structure which enables a garment made thereof to be highly supportive and can lie in close contact with the wearer's skin.

2. Description of Related Art

People's requirements for the fabric structure of clothes are increasing. It is desirable that the fabric structure is breathable, effective in heat dissipation, sweat absorbent, comfortable, and lightweight. Consequently, a variety of weaving methods, fiber materials, and fiber arrangements for the fabric structure of garments were developed.

Take brassieres for example. It is generally required that a bra provides sufficient support for the breasts and will not slip easily. When it comes to bras without shoulder straps, it is further required that such a bra is in close contact with the wearer's skin and will stay where it is supposed to be without slipping; otherwise, the wearer is subject to the embarrassment of having the bra shifted in position.

### BRIEF SUMMARY OF THE INVENTION

In order to solve the forgoing problems, one object of this invention is to provide a fabric structure, wherein the lower fabric layer is knitted with the elastic PU (polyurethane) fibers and thus features superior stretchability, superior resilience, mild stickiness and slip-proofhess.

Accordingly, one embodiment of the present invention provides a fabric structure including an upper fabric layer knitted with a plurality of first PET (polyethylene terephthalate) fibers and a plurality of first PU (polyurethane) fibers; a lower fabric layer 100% knitted with a plurality of second PU fibers; and a central fabric layer interposed between the upper fabric layer and the lower fabric layer, knitted with a plurality of wave-like second PET fibers, wherein crests of the wave-like second PET fibers are intertwined with the upper fabric layer, and wherein troughs of the wave-like second PET fibers are intertwined with the lower fabric layer.

Another embodiment of the present invention provides a fabric structure including an upper fabric layer, a lower fabric layer and a central fabric layer. The upper fabric layer is knitted with a plurality of first PET fibers and a plurality of first PU fibers. The lower fabric layer is knitted with a plurality of second PU fibers and a plurality of third PET fibers, wherein the second PU fibers are knitted into a plurality of first regions, the third PET fibers are knitted into a plurality of second regions, and the first regions and the second regions are arranged alternately and intertwined together. The central fabric layer interposed between the upper fabric layer and the lower fabric layer, is knitted with a plurality of wave-like second PET fibers, wherein crests of the wave-like second PET fibers are intertwined with the upper fabric layer, and troughs of the wave-like second PET fibers are intertwined with the lower fabric layer.

### BRIEF DESCRIPTION OF THE DRAWINGS

The structure and advantages of the present invention will be best understood by referring to the following detailed description of an illustrative embodiment in conjunction with the accompanying drawings, in which:

FIG. 1 is an exploded view schematically showing a fabric structure according to one embodiment of the present invention;

FIG. 2 is a perspective view schematically showing a fabric structure according to one embodiment of the present invention;

FIG. 3 is a diagram schematically showing a lower fabric layer of a fabric structure according to one embodiment of the present invention;

FIG. 4 is a diagram schematically showing an upper fabric layer of a fabric structure according to one embodiment of the present invention. In one embodiment; and

FIG. 5 is a diagram schematically showing an application of a fabric structure according to one embodiment of the present invention.

### DETAILED DESCRIPTION OF THE INVENTION

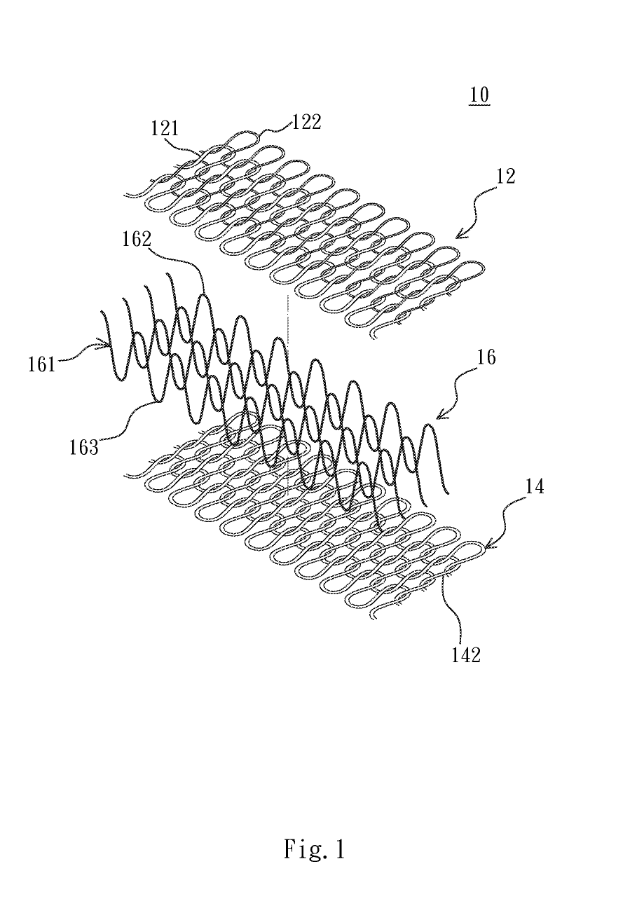

Refer to FIG. 1 an exploded view schematically showing a fabric structure according to one embodiment of the present invention. The fabric structure 10 of the present invention includes an upper fabric layer 12, a lower fabric layer 14 and a central fabric layer 16. A plurality of first PET (polyethylene terephthalate) fibers 121 and a plurality of first PU (polyurethane) fibers 122 are knitted into the upper fabric layer 12. A plurality of second PU fibers 142 is knitted into the lower fabric layer 14. The central fabric layer 16 is interposed between the upper fabric layer 12 and the lower fabric layer 14. The central fabric layer 16 consists of a plurality of wave-like second PET fibers 161. The crests of the wave-like second PET fibers 161 are intertwined with the upper fabric layer 12. The troughs of the wave-like second PET fibers 161 are intertwined with the lower fabric layer 14.

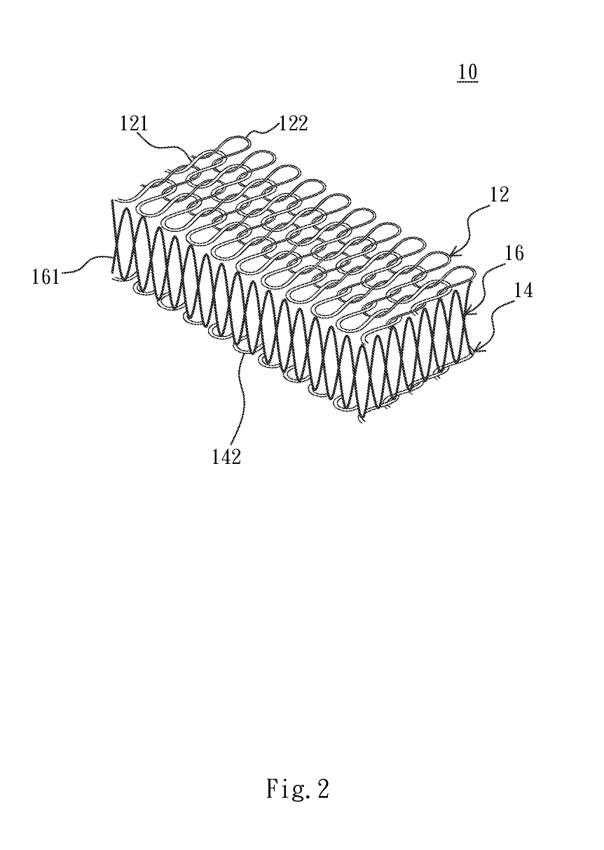

In one embodiment, the upper fabric layer 12 and the lower fabric layer 14 are knitted in a circular knitting method or a warp knitting method. Because of the characteristics of PU material, the lower fabric layer 14, which is 100% knitted with the second PU fibers 142, has stretchability and mild stickiness. Refer to FIG. 2 a perspective view schematically showing a fabric structure according to one embodiment of the present invention, the fabric structure 10 includes three fabric layers: the upper fabric layer 12, the lower fabric layer 14 and the central fabric layer 16. In the embodiment, the central fabric layer 16 is a spacer fabric or a sandwich fabric knitted in a 3D knitting method and has a ripple-like appearance. The second PET fiber 161, which is used to knit the central fabric layer 16, is a monofilament fiber or a multifilament fiber.

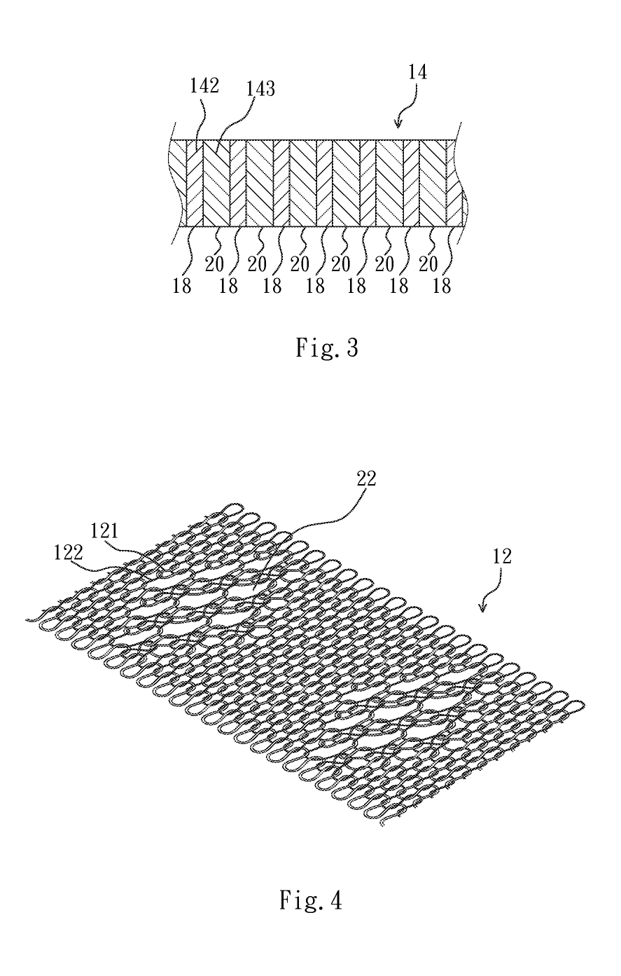

In the foregoing embodiment, the lower fabric layer 14 is 100% knitted with the second PU fibers 142. In another embodiment, the lower fabric layer 14 may be knitted with the second PU fibers 142 plus a plurality of third PET fibers 143. Refer to FIG. 3 a diagram schematically showing a lower fabric layer of a fabric structure according to one embodiment of the present invention. In the embodiment shown in FIG. 3, the lower fabric layer 14 is knitted with a plurality of second PU fibers 142 and a plurality of third PET fibers 143, wherein the second PU fibers 142 are knitted into a plurality of first regions 18, and wherein the third PET fibers 143 are knitted into a plurality of second regions 20. In one embodiment, the first regions 18 and the second regions 20 are in form of strips arranged alternately and intertwined together. The width of the first region 18 is identical to or different from the width of the second region 20. The first region 18 and the second region 20, which are respectively knitted with different materials, have different thicknesses. The lower fabric layer 14 features the cotton tactility of PET fibers and the stretchability and mild stickiness of PU fibers. The present invention does not limit that the second PU fibers 142 and the third PET fibers 143 must be knitted into strips. In the present invention, the second PU fibers 142 and the third PET fibers 143 may be knitted into another shape according to the fabric design.

Refer to FIG. 4 a diagram schematically showing an upper fabric layer of a fabric structure according to one embodiment of the present invention. In one embodiment, the upper fabric layer 12 is knitted to have Jacquard patterns to promote the esthetic effect. As shown in FIG. 4, a portion of the first PET fibers 121 and/or a portion of the first PU fibers 122 are knitted to form at least one Jacquard pattern 22 on the upper fabric layer 12.

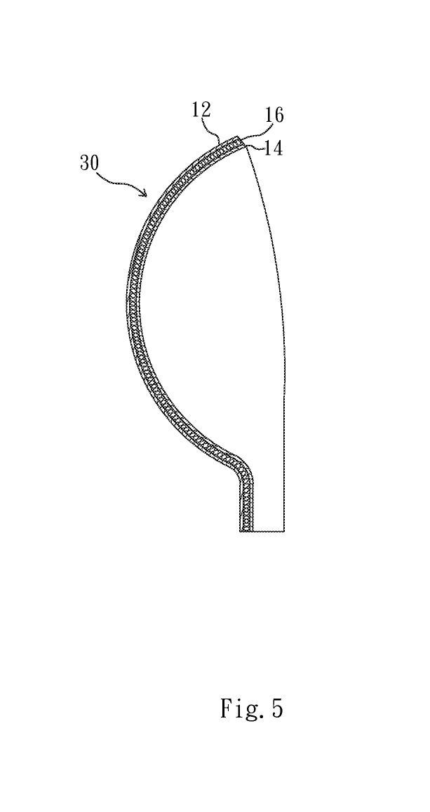

The fabric structure of the present invention may be used as the cloth for female bra. As shown in FIG. 5, while a woman wears the bra 30 made of the fabric structure of the present invention, the ripple-like central fabric layer 16 has a superior moisture permeation effect and a superior air permeation (heat dissipation) effect. The lower fabric layer 14, which is knitted with the PU fibers and features stretchability and mild stickiness, can support the breast very well. Further, the mild stickiness makes the bra contact the skin intimately and unlikely to slip. Therefore, the fabric structure of the present invention can enhance the supportability of the bra and make the bra contact the skin intimately.

In present invention, the upper fabric layers, central fabric layers and lower fabric layer of the fabric structure are all fabricated in knitting methods. The lower fabric layer is 100% knitted with the stretchable PU fibers and thus features superior stretchability, superior resilience, mild stickiness and slip-proolhess.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A fabric structure comprising:
an upper fabric layer knitted with a plurality of first PET (polyethylene terephthalate) fibers and a plurality of first PU (polyurethane) fibers;
a lower fabric layer 100% knitted with a plurality of second PU fibers; and
a central fabric layer interposed between said upper fabric layer and said lower fabric layer, knitted with a plurality of wave-like second PET fibers, wherein crests of said wave-like second PET fibers are intertwined with said upper fabric layer, and wherein troughs of said wave-like second PET fibers are intertwined with said lower fabric layer.

2. The fabric structure according to claim 1, wherein said upper fabric layer and said lower fabric layer are knitted in a circular knitting method or a warp knitting method.

3. The fabric structure according to claim 1, wherein said wave-like second PET fibers are monofilament fibers or multifilament fibers.

4. The fabric structure according to claim 1, wherein a portion of said first PET fibers or a portion of said first PU fibers are knitted into at least one Jacquard pattern on said upper fabric layer.

5. The fabric structure according to claim 1 used to fabricate bra for a woman with said lower fabric layer contacting skin of said woman.

6. A fabric structure comprising:
an upper fabric layer knitted with a plurality of first PET fibers and a plurality of first PU fibers;
a lower fabric layer knitted with a plurality of second PU fibers and a plurality of third PET fibers, wherein said second PU fibers are knitted into a plurality of first regions, and wherein said third PET fibers are knitted into a plurality of second regions, and wherein said first regions and said second regions are arranged alternately and intertwined together; and
a central fabric layer interposed between said upper fabric layer and said lower fabric layer, knitted with a plurality of wave-like second PET fibers, wherein crests of said wave-like second PET fibers are intertwined with said upper fabric layer, and wherein troughs of said wave-like second PET fibers are intertwined with said lower fabric layer.

7. The fabric structure according to claim 6, wherein said first regions and said second regions are in form of strips, and wherein said first regions and said second regions are arranged alternately and intertwined together.

8. The fabric structure according to claim 6, wherein said upper fabric layer and said lower fabric layer are knitted in a circular knitting method or a warp knitting method.

9. The fabric structure according to claim 6, wherein said wave-like second PET fibers are monofilament fibers or multifilament fibers.

10. The fabric structure according to claim 6, wherein a portion of said first PET fibers or a portion of said first PU fibers are knitted into at least one Jacquard pattern on said upper fabric layer.

11. The fabric structure according to claim 6 used to fabricate bra for a woman with said lower fabric layer contacting skin of said woman.
